(19) United States
(12) Patent Application Publication
(10) Pub. No.: US 2023/0235775 A1
(43) Pub. Date: Jul. 27, 2023

(54) RACKING CARABINER

(71) Applicant: TREEMAGINEERS LTD, Pitlochry (GB)

(72) Inventors: Christopher COWELL, Pitlochry, Perth & Kinross (GB); Elliot TANNER, Montgomery, Powys (GB)

(21) Appl. No.: 17/928,801

(22) PCT Filed: Jun. 1, 2021
(86) PCT No.: PCT/GB2021/051342

§ 371 Date: Nov. 30, 2022

(30) Foreign Application Priority Data
Jun. 1, 2020 (GB) 2008167.5

(51) Int. Cl. F16B 45/02; F16B 45/00

(52) U.S. Cl. CPC F16B 45/023; F16B 45/005; F16B 45/024; F16B 45/028; F16B 2001/0035

(57) ABSTRACT

A racking carabiner includes a carabiner body with pivot end and nose end portions defining an opening. A gate pivotally connects to the body at the pivot end portion, and pivotable between closed and open positions. A gate retainer can adopt an inoperative condition, in which it presents no restriction to gate movement and an operative position in which it inhibits movement of the gate from a retained-open position towards the closed position. The retainer secures the gate in an open position for as long as it is convenient for the user. The gate clip can be returned to the inoperative condition, whereupon the carabiner gate can be opened and will spring closed as it would in a conventional racking carabiner.

### BACKGROUND OF THE INVENTION

### Field of the Invention

This invention relates to a racking carabiner.

### Description of the Related Art

A racking carabiner is a special type of carabiner the primary purpose of which is to provide its user with convenient access to tools or equipment by holding them securely in a convenient location when not required for use, while allowing them to be removed easily when required with one hand. An example of a racking carabiner is disclosed in EP-A-3 001 047 of the present applicant, the content of which is incorporated herein by reference. A racking carabiner may be used at height by a working climber, a sport climber, arborist, or in any other circumstance in which it is convenient to carry tools or other pieces of equipment, at height or otherwise.

Typically, a carabiner includes a C-shaped body that has an opening, and a gate, carried on the body; a retention space is defined within the body. The gate can be pivoted between a closed position, in which it obstructs the opening to form a continuous loop with the body, and an open position in which the opening is at least partly unobstructed to enable an item to pass into or out of the retention space. In most carabiners, the gate is biased towards the closed position, such that it will snap shut, unless it is manually opened or otherwise obstructed.

There are some situations in which automatic closure of the gate of a racking carabiner is not advantageous. For example, it may be a piece of work requires that a tool be repeatedly removed from the racking carabiner to perform a specific task, and subsequently replaced on the carabiner when another task is being performed. If the gate has to be opened on each occasion, then this can be an obstacle to achieving an efficient workflow.

### SUMMARY OF THE INVENTION

An aim of this invention is to provide a racking carabiner that can be used in a conventional manner, in which the gate snaps closed, or in an alternative mode in which the gate remains open until the user chooses to allow it to close.

To this end, the present invention provides a racking carabiner comprising:
a. an approximately C-shaped carabiner body that has a pivot end portion and a nose end portion, between which an opening is defined;
b. a gate pivotally connected to the body at the pivot end portion, and pivotable between a closed position, in which a connecting end portion of the gate engages with the nose end portion of the body to form a complete loop with the body and close its opening, and open positions in which the connecting end portion of the gate is spaced from the nose end portion of the body to at least partially open its opening;
c. a gate retainer that can adopt an inoperative condition, in which it presents no restriction to movement of the gate between the closed and open positions and an operative position in which it inhibits movement of the gate from a retained-open position towards the closed position.

This allows a user to secure the gate in an open position for as long as it is convenient for the user. The gate clip can be returned to the inoperative condition, whereupon the carabiner gate can be opened and will spring closed as it would in a conventional racking carabiner. It is particularly preferable that the gate retainer cannot move from the operative condition without deliberate action from a user, and that it is resistant to movement from the operative condition under the influence of an item being passed through the opening into the body of the carabiner. This is in contrast to known carabiners that are intended to close automatically, such as those disclosed in U.S. Pat. No. 5,005,266 and US-A-2011/0113604. This aim can be achieved by designing the carabiner to maximise the distance between the gate retainer and the nose end portion of the body when the gate is in the retained-open position and the gate retainer is in the operative condition.

The gate retainer may be carried on one or other of the carabiner body and the gate of the carabiner.

The gate retainer may include a clip that can be transformed between the inoperative and operative conditions by pivoting it about a connection with a component of the carabiner to which it is connected between inoperative and operative positions. The gate retainer may include biasing components that urge the clip to pivot towards the inoperative position. For example, the biasing components include one or more springs that act between the clip-and the carabiner body.

Alternatively or additionally, the clip may be formed of resilient material, such as a polymer or metal wire, that is deformed by pivoting between the inoperative and operative positions, such deformation giving rise to a restoring force that urges the gate towards the closed position.

The clip may be U-shaped, typically having two side arms interconnected by a crossbar. In the operative condition, the side arms may be located on opposite sides of the gate. In the operative condition, the crossbar may be received into a groove on the gate.

The gate retainer may include a toggle assembly that has an elongate flexible element to which a toggle is attached, the flexible element being secured to one of the carabiner body or the gate and the toggle being releasably connectable to the other of the carabiner body or the gate to retain the gate in a retained-open position. Preferably, the elongate element is elastomeric, which can assist in connecting or disconnecting the toggle.

The gate retainer may include a first magnetic element secured to the gate and second magnetic element secured to the carabiner body, the first and second magnetic elements being operative to maintain the gate at a retained-open position by their mutual magnetic attraction. Both magnetic elements may be permanent magnets, or one may be a permanent magnet and the other a piece of ferromagnetic material.

In the operative condition, the gate retainer may inhibit movement of the gate from a retained-open position towards the closed position; the gate being movable to a fully-open position wherein the retained-open position is between the fully-open position and the closed position. This allows a typically small amount of movement of the gate when it is held by the gate retainer. Displacement of the gate retainer from the operative condition requires movement of the gate from the retained-open position towards the fully-open position. This can be used to provide a detent whereby an external force must be applied to the gate retainer to displace it from the operative condition.

Most typically, the carabiner body includes attachment components which can be used to connect the carabiner to a supporting structure, such as a belt or a webbing or other component of a harness.

In embodiments of the invention the carabiner body is a one-piece component. Alternatively, the carabiner body may include a body component and a closing component, the closing component being pivotally interconnected to the body and movable between an open condition and a closed condition in which, in the closed condition, the body and a closing component are in contact with one another at a contact location remote from the pivotal interconnection, a slot being defined between portions of the body and the closing component respectively and extending between the pivotal interconnection and the contact location; and in the open condition, the body and a closing component are spaced from one another at the contact location, thereby opening the slot; there being a locking arrangement that can be operated to prevent movement of the closing component from the closed condition.

From a second aspect, this invention provides an arrangement for carrying articles comprising a first component that has an attachment formation and a carabiner embodying the first aspect of the invention.

The attachment formation may be part of an item that is configured to be worn by a user. For instance, it may be a component of a harness or a belt, such as a tool-carrying belt.

### BRIEF DESCRIPTION OF THE DRAWINGS

Embodiments of the invention will now be described in detail, by way of example, and with reference to the accompanying drawings, in which:

FIGS. 1 and 2 show a first embodiment of the invention in a closed and an open condition;

FIGS. 3 and 4 are first and second exploded views of the embodiment of FIGS. 1 and 2;

FIGS. 5 and 6 are part-transparent views of the gate of the embodiment of FIGS. 1 and 2 in a closed and an open condition;

FIGS. 7 and 8 show in detail the nose of a gate of the embodiment of FIGS. 1 and 2 in an open condition, unlocked and free to close;

FIGS. 9 and 10 show a detail of a spine of the embodiment of FIGS. 1 and 2 with the gate clip in an inoperative position;

FIGS. 11 and 12 show in detail the nose of a gate of the embodiment of FIGS. 1 and 2 retained in an open condition by a gate clip;

FIGS. 13a and 13b show, in detail, an end portion of the gate at its fully-open position and at a position at which it is retained by the gate clip;

FIG. 14 shows the path taken by components of the gate retention clip in relation to other components of the embodiment as it moves between an operative and an inoperative position;

FIGS. 15 to 17 show in detail alternative arrangements by which a gate clip can be connected to a body component of first embodiment of the invention;

FIG. 18 shows a second embodiment of the invention;

FIG. 19 shows the interconnection of the gate clip and body component in the embodiment of FIG. 18;

FIGS. 20 and 21 are a semi-transparent view and a cross-section through a mounting arrangement the second embodiment of FIG. 18;

FIGS. 22 and 23 show a third embodiment of the invention;

FIG. 24 is a detail of a gate clip and gate nose of the embodiment of FIGS. 21 and 22;

FIGS. 25 to 27 show a gate clip and gate clip arrangement of a fourth embodiment of the invention;

FIGS. 28 to 30 show a gate clip and gate clip arrangement of a fifth embodiment of the invention;

FIGS. 31 and 32 show a sixth embodiment of the invention in a closed and an open condition;

FIGS. 33a to 33c show the sequence of a gate clip locking the gate of the embodiment of FIGS. 31 and 32;

FIG. 34 shows the gate clip of the embodiment of FIGS. 30 and 31 in operation in retaining the gate;

FIGS. 35 and 36 show a seventh embodiment of the invention in a closed and an open condition;

FIG. 37 shows in cross section a toggle assembly being a gate retaining component of the embodiment of FIGS. 34 and 35;

FIGS. 38a and 38b show the toggle assembly of FIGS. 34 to 36 being deployed for use;

FIGS. 39 to 41 show an eighth embodiment of the invention in a closed and an open condition; and

FIGS. 42 and 43 show a sequence of attaching the embodiment of FIGS. 1 and 2 to a belt or a component of a harness.

### DESCRIPTION OF THE PREFERRED EMBODIMENTS

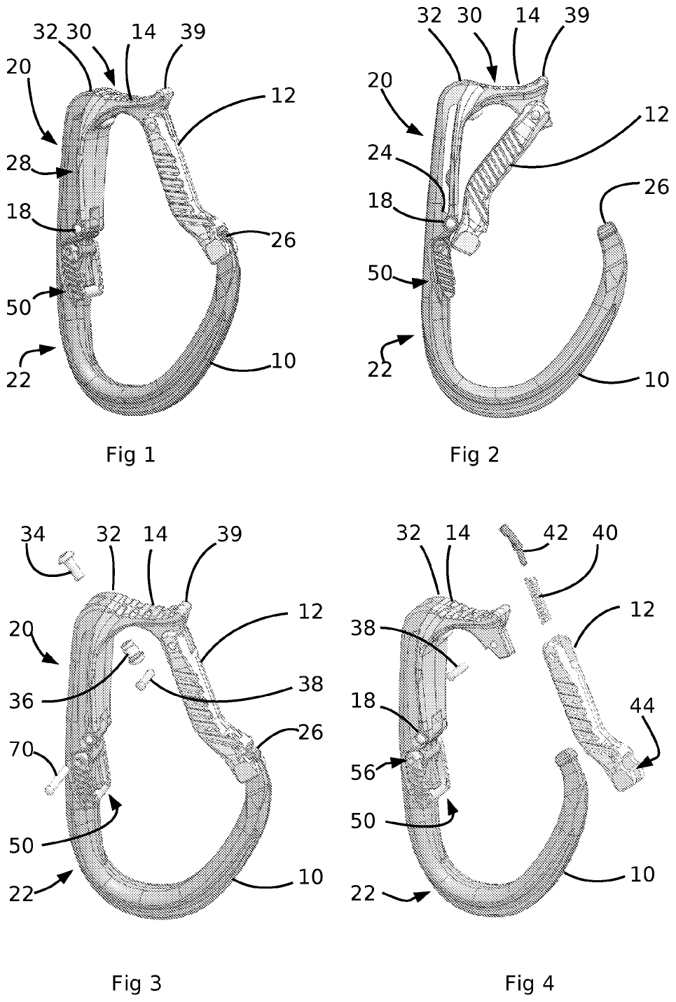

For convenience of description, the carabiner will be described in the orientation as shown in FIGS. 1 and 2, and terms such as “top”, “bottom”, “upper” and “lower” should be interpreted as referring to the carabiner in that orientation. This is the approximate orientation that the carabiner will adopt when in normal use. While the embodiments are described with respect to connection to a work harness, embodiments may be used in connection to other items, such as a tool belt or a sport harness.

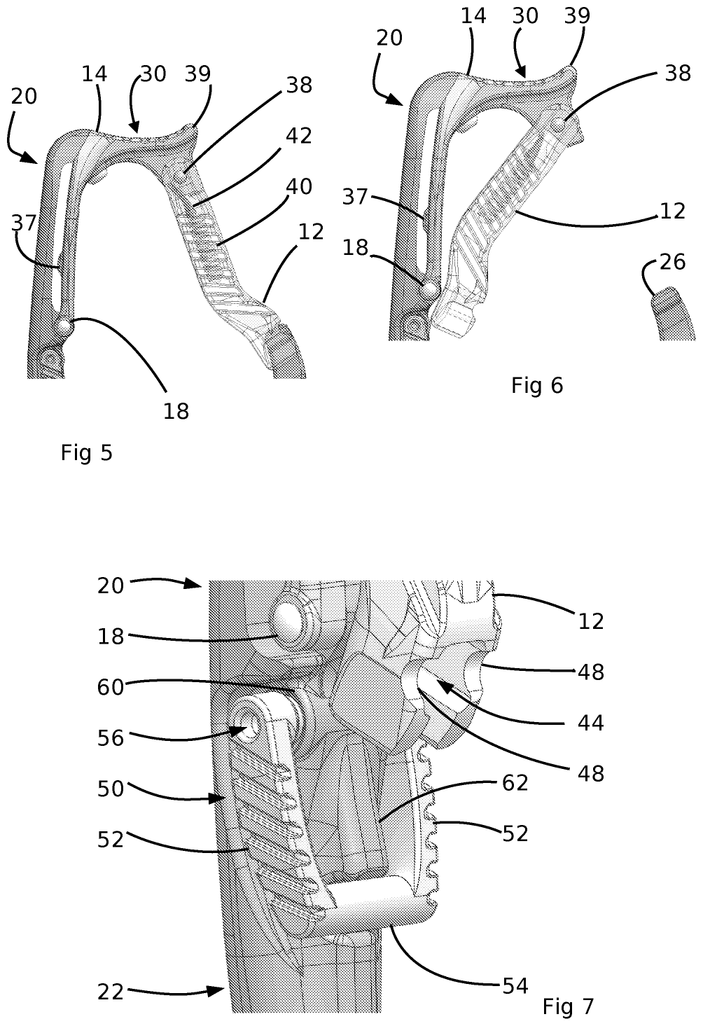

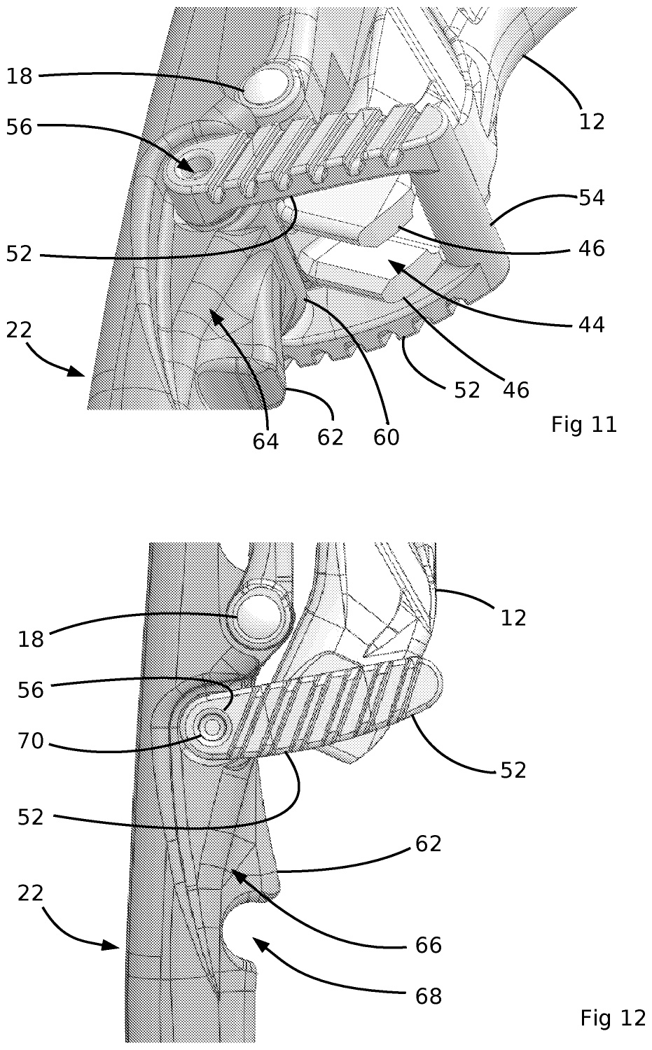

With reference first to FIGS. 1 to 16, a racking carabiner embodying the invention includes a C-shaped body that includes a main body component 10 and a closing component 14, and a gate 12. In this embodiment, each of these components is formed from lightweight metal alloy materials. However, in other embodiments, some or all of the components may be made of, for example, plastics.

The main body component 10 is broadly J-shaped within a plane, with a spine that has an upper section 20 and a lower section 22. A tool carrying portion extends from the spine, and curves through approximately 180° in a plane to end approximately opposite the midpoint of the spine. At the interface between the upper and lower sections 20, 22 of the spine, a flange 24 is formed on the main body component 10. A pivot hole extends through the flange 24. A recess is formed in the upper section 20, extending between the flange 24 and a boss 32 close to the upper end of the upper section 20.

The closing component 14 is shaped generally as an upside-down “L”, having a shaft portion 28 and a cross portion 30 that extend approximately at a right angle to one another. The shaft portion 28 of the closing component 14 has a forked end section that is connected to the main body component 10 by a pivot pin 18 that passes through the forked end section and the pivot hole through the flange 24.

The closing component 14 can pivot with respect to the main body component 10 between an open condition (shown in FIG. 42) and a closed condition (shown in the other figures). In the closed condition, the shaft portion 28 lies generally parallel to the upper section 20 of the spine of the main body component 10, and makes contact with the boss 32 whereby the main body component 10 and closing component 14 together form a C-shaped carabiner body. With the closing component 14 in the closed condition, a slot is formed between the shaft portion 28 and the recess in upper section 20. The closing component 14 can be retained in the closed condition by a bolt 34 and nut 36 (or other fastener or closure system) that passes through the boss 32 into a hole in the closing component 14. In the absence of the bolt 34, the closing component 14 can be pivoted away from the main body component 10 to the open condition. The purpose of the bolt is to either permit or to prevent this pivoting movement. In other embodiments, alternative components can be provided to achieve this function.

The gate 12 is connected to the cross portion 30 of the closing component 14 remote from the shaft portion 28 such that the gate can pivot about a pin 38 on the closing component within the plane of the body 10. A spring 40 and pusher 42 are incorporated into the gate to urge the gate towards the closed position in a manner familiar to those skilled in the technical field. When the closing component 14 is in the closed position, a connecting end portion of the gate 12 is sprung into contact with a nose 26 at an end portion of the lower section 22 of the main body component 10. In the closed position, the nose 26 enters into a recess 44 defined between two spaced flanges 46 at the connecting end portion of the gate 12 to resist deflection of the gate 12 in the event that it is loaded from within the loop. In that condition, the gate 12 forms a continuous loop with the body and the closing component 14 to define a retaining space within the loop.

The embodiment as it has been described so far is essentially the same as that disclosed in EP-A-3 001 047. The features that implement the present invention will now be described. It should be noted that, in each case, a corresponding embodiment of the invention could be formed by a conventional, one-piece carabiner back.

In this embodiment, the gate 12 has a respective notch 48 of arcuate concave cross-section extending across each of the flanges 46.

This embodiment of the invention further includes a gate clip 50 of resilient polymer to constitute a gate retainer. The gate clip 50 is generally U-shaped having two side arms 52 interconnected by a crossbar 54, the gate clip 50 being symmetrical about a centre plane. Close to an end remote from the crossbar 54, a mounting arrangement 56, which will be described fully below, is provided on each arm 52. The gate clip 50 is carried on the spine of the carabiner at a connection region disposed between the upper section 20 and the lower section 22 of the spine. The connection region includes a boss 60 that extends across the spine, through which a bore is formed. A central rib 62 extends in the plane of the spine, a recess 64 being formed in the spine to each side of the rib 62. A groove 68 of approximately semi-circular cross section extends across the rib 62. The gate clip 50 is connected to the spine by a pivot pin 70 that passes through the mounting arrangements 56 in the arms 52 and the bore in the boss 60.

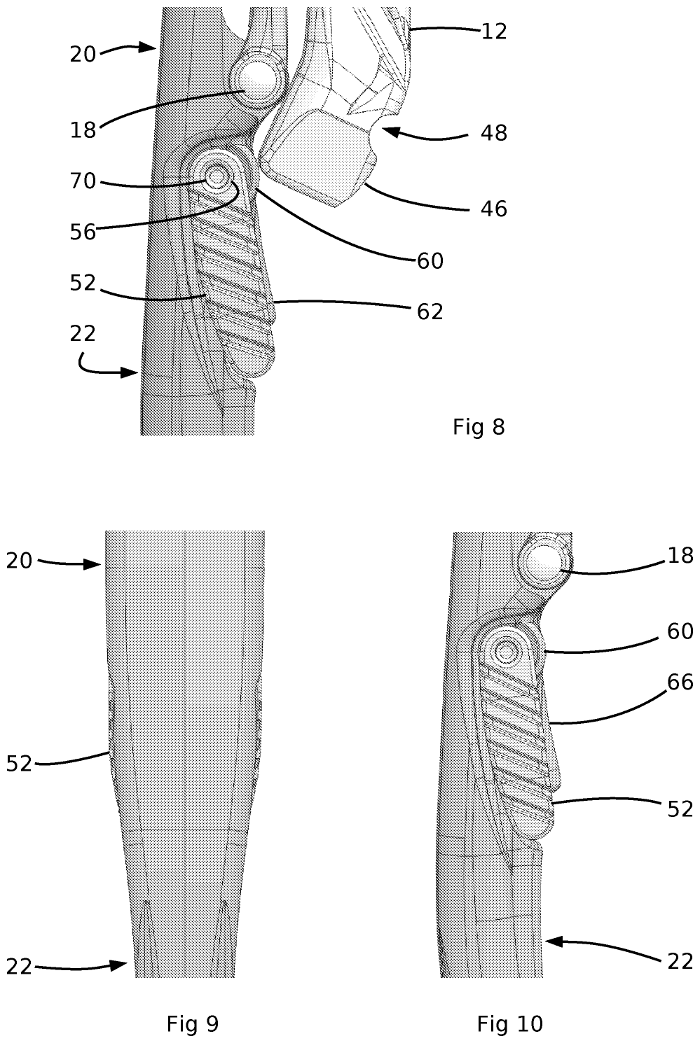

The gate clip 50 can be pivoted about the pivot pin 70 between an inoperative position and an operative position. The gate clip 50 is shown in the inoperative position in FIGS. 1 to 10. In this position, each side arm 52 of the gate clip 50 is received within one of the recesses 64 and the crossbar 54 is received within the groove 68. The crossbar 54 is received behind a small projection of the rib 62, as will be discussed in more detail below. In the inoperative position, the gate clip 50 does not interact with the gate 12, which means that the gate 12 can be opened fully and can be allowed to close under spring force. As can be seen from FIGS. 8, 9 and 10, in this position, the gate clip 50 projects only minimally from the spine of the carabiner, so provides no obstacle to its use and also so that the risk of getting caught or snagged upon another object is minimised. Therefore, with the gate clip in the inoperative position, the carabiner of this embodiment operated, is substantially the same in function and application as the carabiner shown in EP-A-3 001 047.

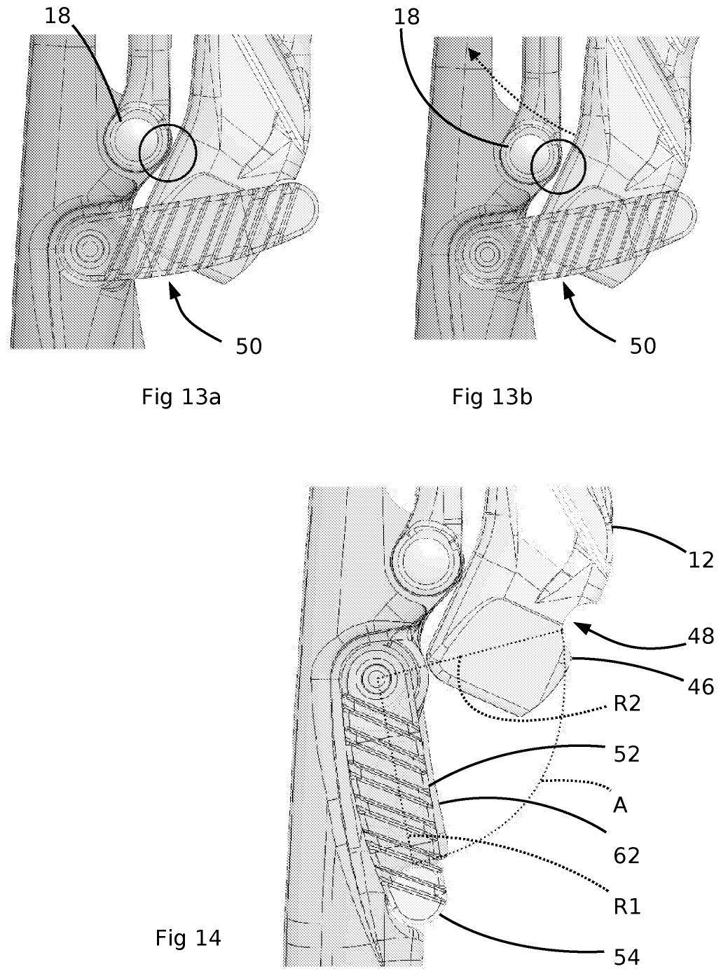

When the gate 12 is displaced from its closed position, limitation of its movement is reached when the gate 12 comes into contact with the spine adjacent to the pivot pin 18. When in this maximally open position, the gate clip 50 can be rotated away from the inactive position until the crossbar 54 comes into contact with the flanges 46 at the end of the gate 12, as shown circled in FIG. 13a. Once contact has been made, the gate clip 50 can be pushed until the crossbar 54 passes over the flanges until it enters the notch 48. When pressure on the gate 12 is subsequently released, it may move a short distance away from the maximally open position towards the closed position, so there is clearance between the gate 12 and the connecting component 14, as shown circled in FIG. 13b, whereupon its further movement is prevented by the crossbar 54 of the gate clip 50. In this position, referred to as the retained-open position, the gate clip 50 is retained by the notch 48 to inhibit it from pivoting towards the inoperative position. However, the small amount of clearance between the gate 12 and the connecting component 14 allows the crossbar 54 to slide out of the notch 48 on application of a significant, but not excessive, manual force to the gate clip 50. The presence of the notch 48 lessens the extent by which the crossbar 54 projects from the gate 12 into the space within the loop of the carabiner when the gate clip 50 is in the operative position, thereby reducing the likelihood that the gate clip 50 will be dislodged from the operative position by an item introduced into the loop of the carabiner.

In FIG. 14, the dotted line A shows the path of the radially innermost surface of the crossbar 54 between the inoperative position (radius R1) and the operative position (radius R2). Immediately adjacent to the inoperative position, the path A intersects with a projecting end part of the rib 62. Likewise, immediately adjacent to the operative position, the path A intersects with a projecting end part of the flanges 46 next to the recesses. This causes the gate clip 50 to snap into each of the inoperative and operative positions, so as to require deliberate application of manual force to move the gate clip 50 away from either of these positions. The angle at which the gate retention clip 50 acts upon the gate 12 ensures that the force of return spring does not tend to cause the gate retention clip 50 to be urged from the notch 48.

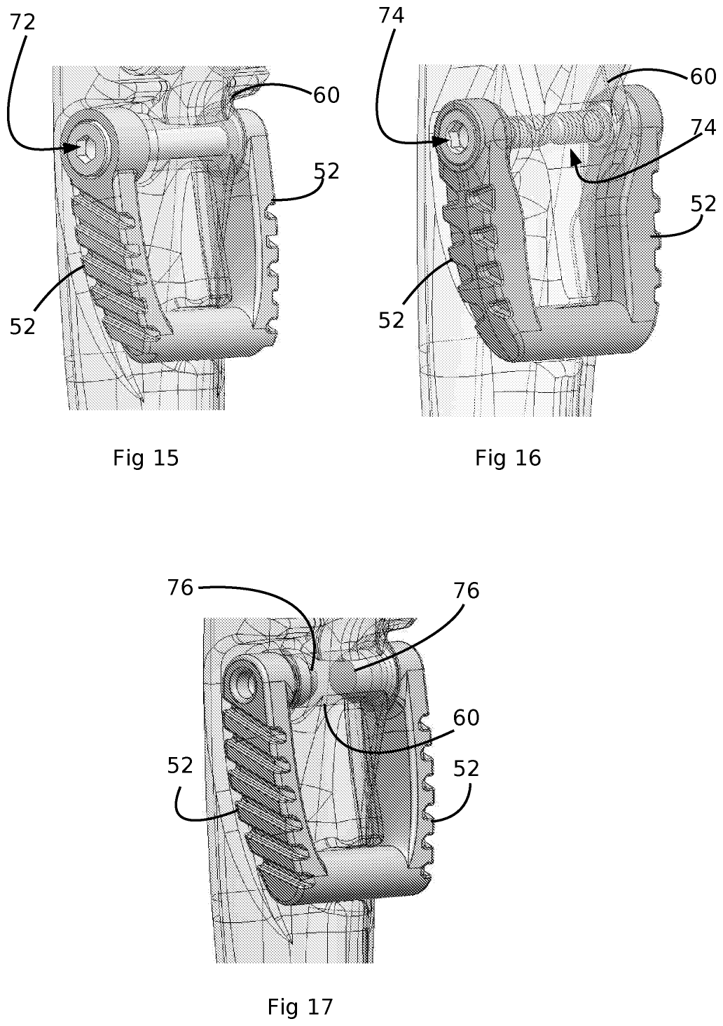

FIGS. 15 to 17 show alternative arrangements whereby the gate clip 50 can be secured to the body component 10. In the arrangement of FIG. 15, the mounting arrangement comprises a bolt 72 that has a head received in a counterbore in one side arm 52 of the gate clip 50 and a shank that passes through the bore in the boss 60, an end of which is received within a tapped hole in the other side arm 52. The shank therefore acts as a pivot pin in this arrangement. In the arrangement of FIG. 16, there are two coaxial cap screws 74, each one having a head received on a counter bore of a respective side arm 52 and a shank threaded into the bore in the boss 60. The shanks are fixed within the boss 60 against rotation and the gate clip 50 can pivot around the cap screws 74. In the arrangement of FIG. 17, a projecting stud 76 of circular cross-section is provided on each of the side arms 52, the studs 76 being coaxial. Each stud 76 projects into the bore in the boss 60 within which each is a close but not binding fit Therefore, the gate clip 50 can rotate with respect to the body component 10 about the studs 76. The gate clip 50 can be installed onto or removed from the body component by pulling the side arms 52 apart against the natural resilience of the material of the gate clip.

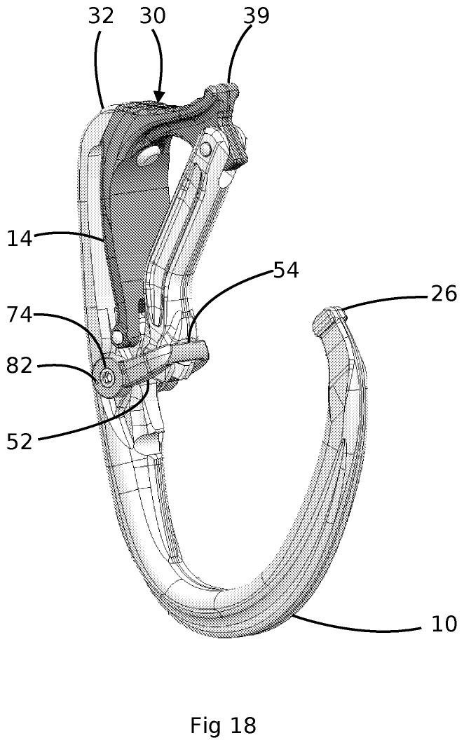

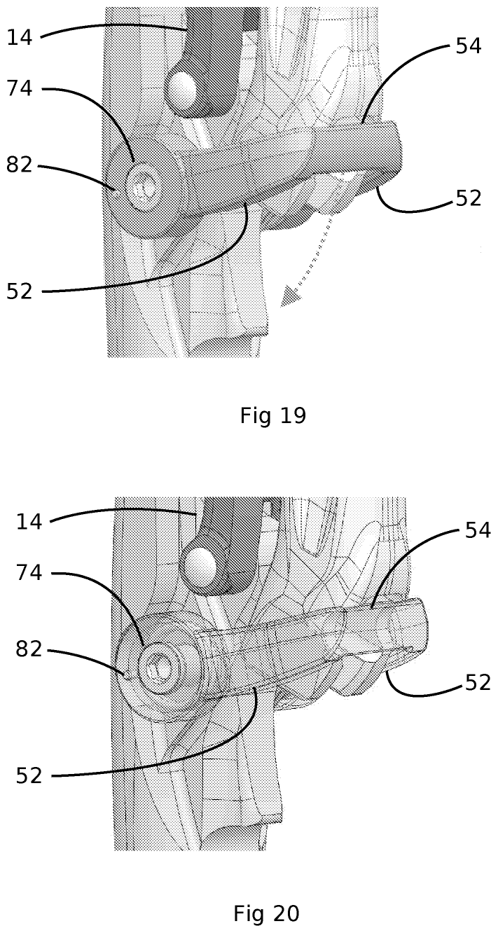

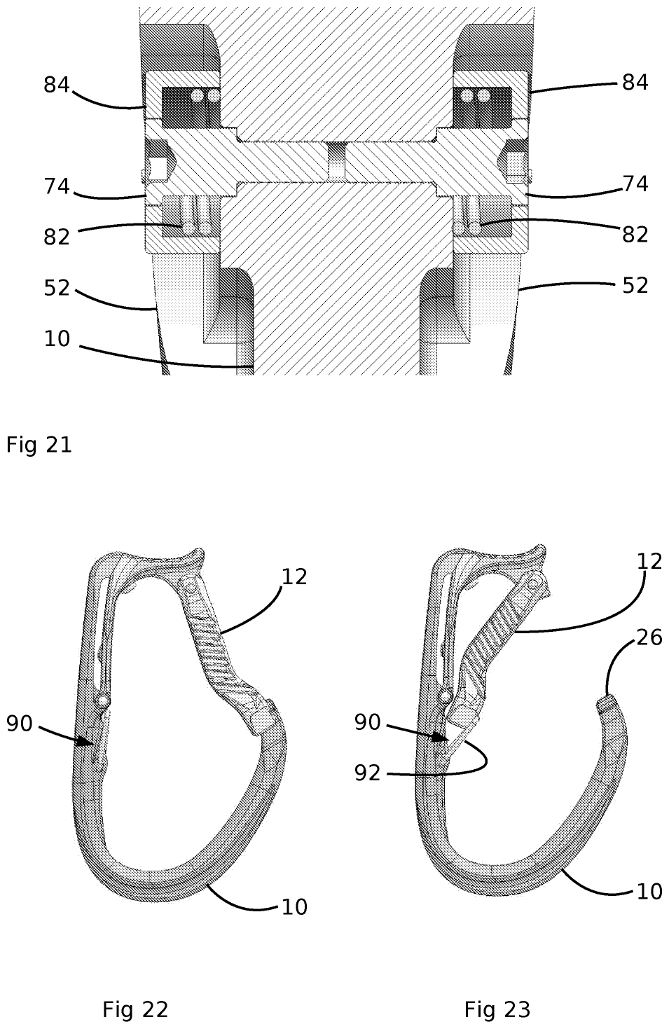

With reference to FIGS. 18 to 21, a second embodiment is shown. This embodiment includes all the features of the variations of the first embodiment as described above.

In addition, this embodiment includes return springs that bias the gate clip 50 to the inoperative position. A single spring may be used in place of the two in this embodiment. The example illustrated is a modification of the arrangement of FIG. 16, which uses two cap screws 74 to secure the gate clip 50 to the body component 10. In this embodiment, a respective torsion spring 82 connects each side arm 52 to the body component 10. The torsion springs 82 each have several coils surrounding the shank of the cap screw 74 and end legs that are each received in a hole in the body component 10 and in the side arm 52 located radially outwardly from the cap screw 74, shown at 80. The springs 82 are configured such that the torque that they apply to the gate clip 50 increases as it is moved away from its inoperative position. A shroud 84 is applied to each of the side arms 52 to cover the springs 82 and allow access to the cap screw.

In the first embodiment discussed above, the gate clip 50 is retained in the inoperative position and a deliberate force is required to move it from that position. This need not be the case in the present embodiment Instead, the springs 82 are typically selected to ensure that they exert force upon the gate clip 50 that is less than that required to move the gate clip from the inoperative position. However, if the gate clip 50 is suddenly released at the retained-open position, under the action of the springs 82 it will be moving with sufficient speed to overcome the resistance to its attaining of the inoperative position, where it will subsequently retained.

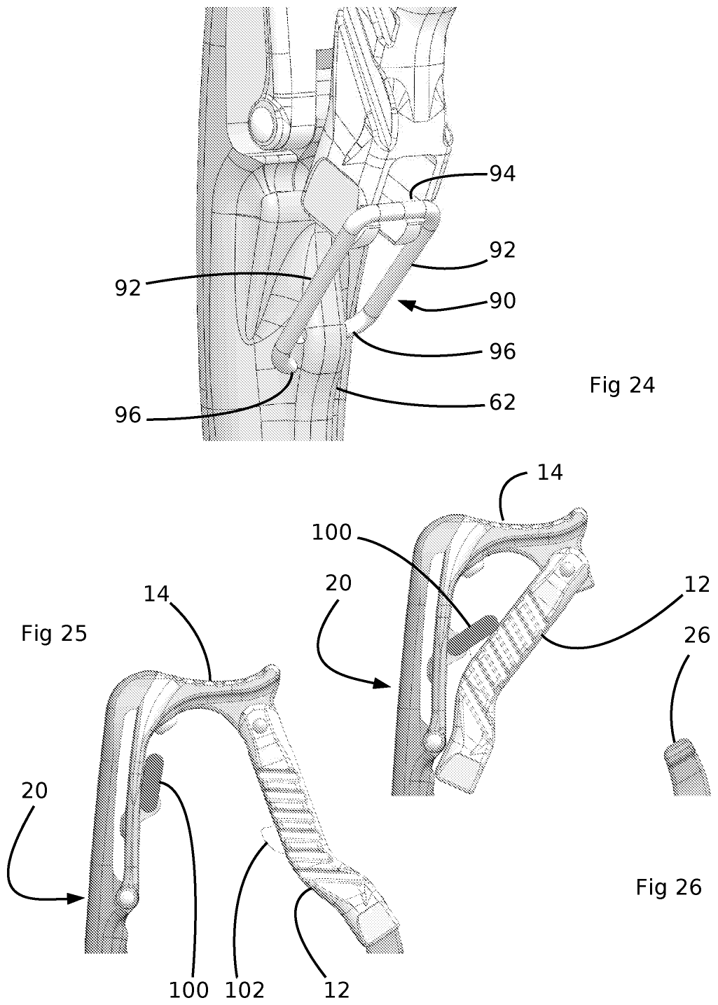

In the embodiment of FIGS. 22 to 24, the gate clip 90 is formed from a loop of resilient metal wire formed in a manner similar to the gate of a wire carabiner gate. The gate clip 90 is generally U-shaped with two side arms 92 interconnected by a crossbar 94. The side arms 92 have short end portions 96 turned in towards one another parallel to the crossbar. The side arms 92 are of unequal length such that the two end portions 96 are at different distances from the crossbar 94. The end portions 96 are each received within a respective hole in the rib 62 within which they can rotate.

When in the inoperative position, as shown in FIG. 22, the gate 90 lies substantially in a plane. As the gate 90, the unequal length of the side arms 92 causes them to rotate at different rates about the respective holes, so twisting them out of a common plane, with the crossbar 94 acting as a torsion spring interconnecting the side arms 92. The torque applied by the crossbar 94 upon the side arms 92 acts to cause the gate 90 to be urged towards the inoperative position. Preferably, the gate 90 is configured such that when in the inoperative position the crossbar 94 continues to apply a torque to the side arms 92 to give rise to a retaining force that maintains the gate 90 in the inoperative position.

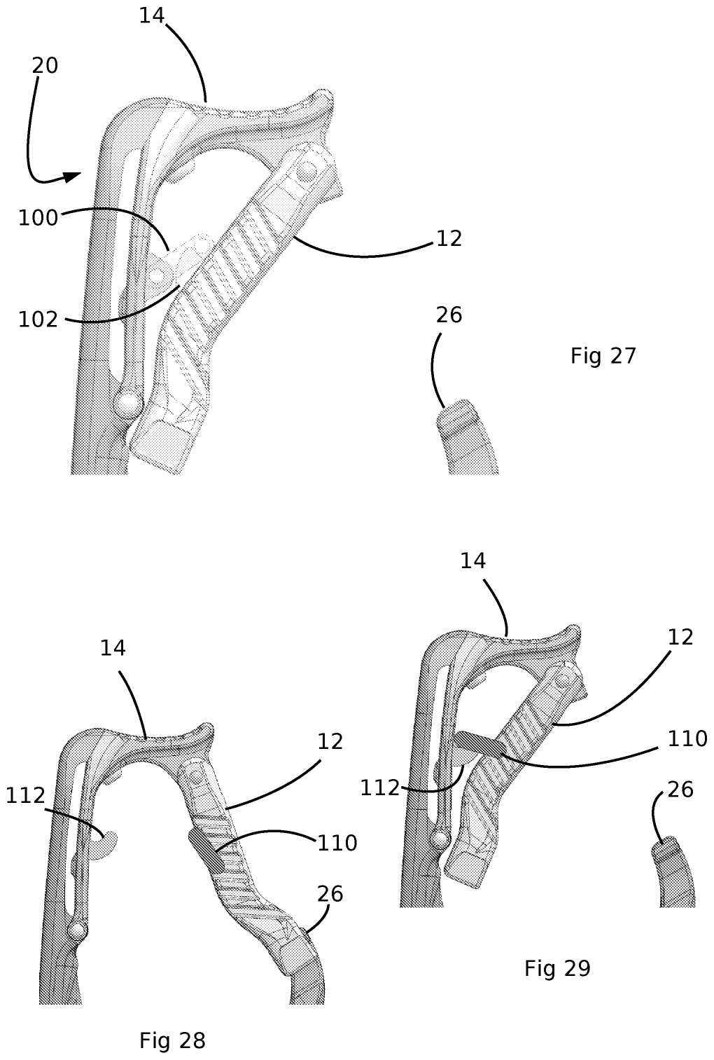

The embodiment of FIGS. 25 to 27 show one alternative possible arrangement of the gate clip. In this embodiment, the gate clip 100 is pivotally carried on the closing component 14 and interacts with a hook 102 that is carried on the gate 12.

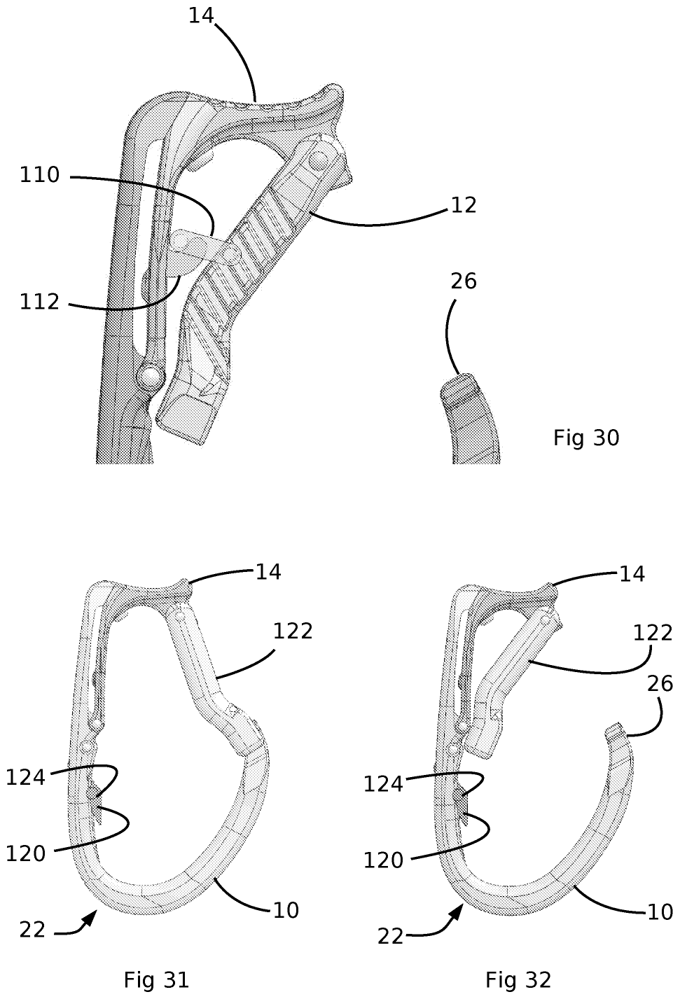

The embodiment of FIGS. 28 to 30 shows another alternative possible arrangement of the gate clip. In this embodiment, the gate clip 110 is pivotally carried on the gate 12 and interacts with a hook 112 that is carried on the closing component 14.

The embodiments described above require a gate that is specially adapted for use in the embodiment. The embodiment of FIGS. 31 to 33 makes use of a gate that is unchanged from that of EP-A-3 001 047.

In this embodiment, the gate clip comprises a planar finger 120 that is pivotally connected to the body component 10 by a pivot 126. A cylindrical peg 124 projects from opposite faces of the finger 120.

In the inoperative position, the gate clip is pivoted such that the finger 120 is largely contained within a slot 128 formed in the lower section 22 of the spine adjacent to the pivot pin 18. However, sufficient of the finger remains outside the slot 128 to ensure that it can be easily lifted by a user. Optionally, springs may be provided to return the gate clip to the inoperative condition.

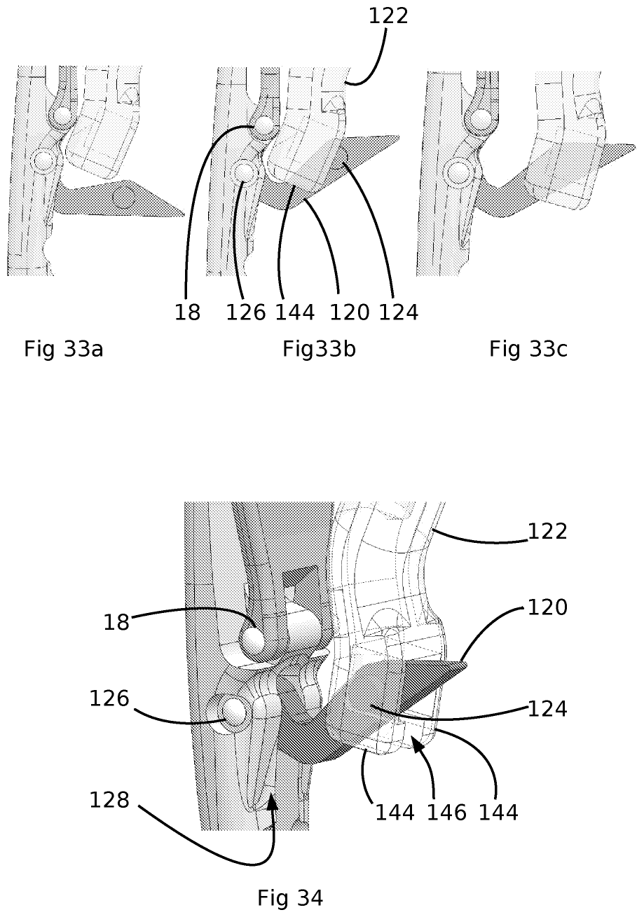

To operate the gate clip of this embodiment of the invention, the user moves the gate 1224 to a fully-open position in which it makes contact with the body. The finger 120 and pegs 124 of the gate clip pass between the flanges 144 to enter the recess 146 of the gate 122, as shown in FIGS. 33a to 33c. The user then releases the gate 122 to allow its spring to start to move it towards its closed position. This movement is stopped when the pegs 124 reach the bottom of the recess 146. In this retained-open position of the gate 122, interaction between the pegs 124 and the flanges 144 prevent the gate clip from pivoting towards the inoperative position. To allow the gate clip to be released, the user must first move the gate 122 to the fully-open position, whereupon the gate clip can manually or under the action of a spring return to the inoperative position whereupon the gate 122 can close.

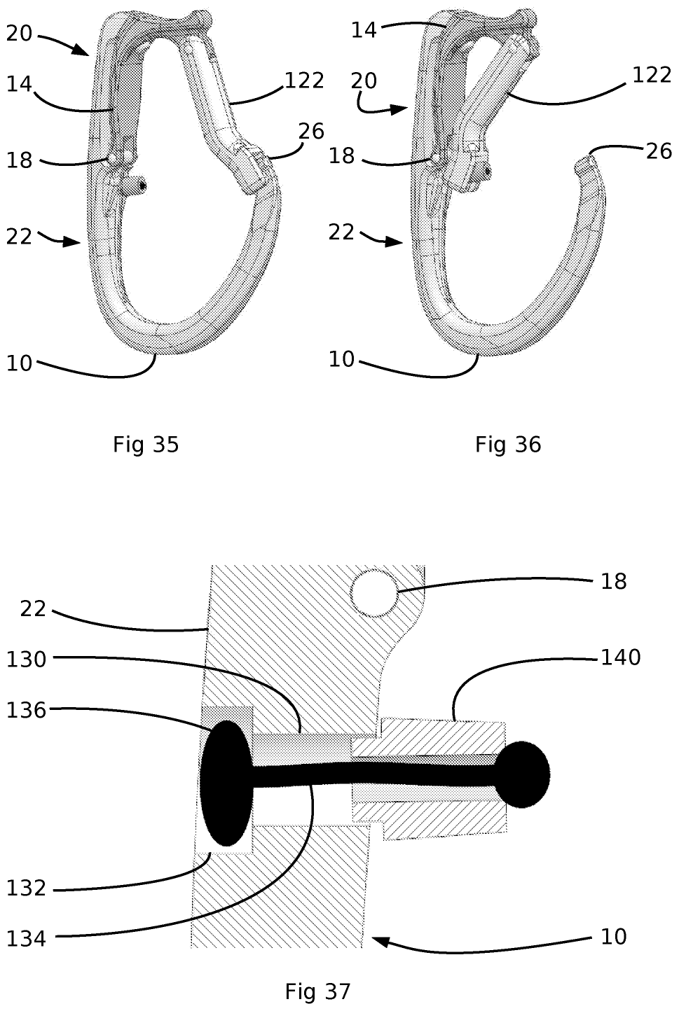

In a variation of the last embodiment, as shown in FIGS. 35 to 38, which can further simplify the design of the carabiner, the gate retainer is constituted by a toggle assembly; there is no gate clip. The gate of this embodiment is the same as that described with reference to FIGS. 31 to 34.

A hole 130 is formed through the lower section 22 of the spine close to the pivot pin 18, an outer end part 132 of the hole 130 being counterbored. The toggle assembly includes an elastomeric tensile cord 134 that passes through the hole 130. An enlarged head 136 is attached to one end of the tensile cord 134, the head 136 being received within the counterbore 132 and being unable to pass through the part of the hole 130 that is not counterbored. A toggle 140 is carried on the tensile cord 134. The toggle 140 has an axial through bore through which the tensile cord 134 passes and has an annular cross-section throughout its length. The outer diameter of the toggle 140 tapers away from the body 10, with a short end portion being of a lesser diameter cylinder, which is a close fit within the hole 130, where it is retained in an inoperative condition, as shown in FIGS. 34 and 36.

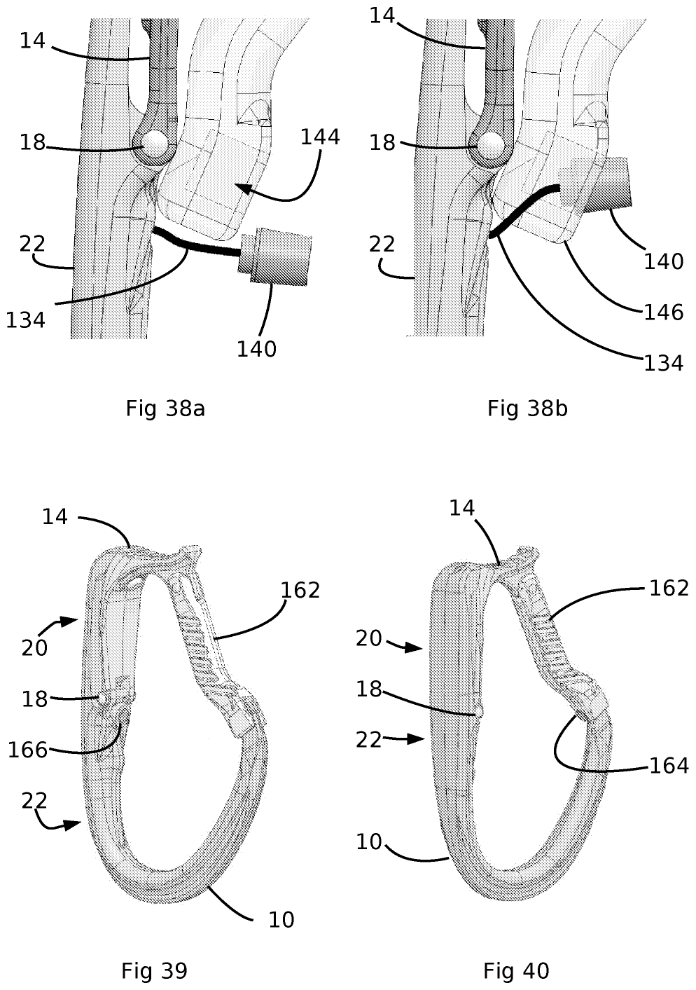

To operate this embodiment, the user moves the gate 122 to a fully-open position in which it makes contact with the body. The user then pulls the toggle 140 away from the body component 10, causing the tensile cord 134 to stretch. The tensile cord 134 passes between the flanges 146, whereupon the user can allow the toggle 140 to be pulled into enter the recess 144 of the gate 122, as shown in FIGS. 38a and 38b. The elastic force of the tensile cord 134 is sufficient to inhibit return of the gate 122 to the closed position—the toggle assembly is therefore operative to retain the gate 122 in a retained-open position. The gate 122 can be closed by the user reversing the above described sequence.

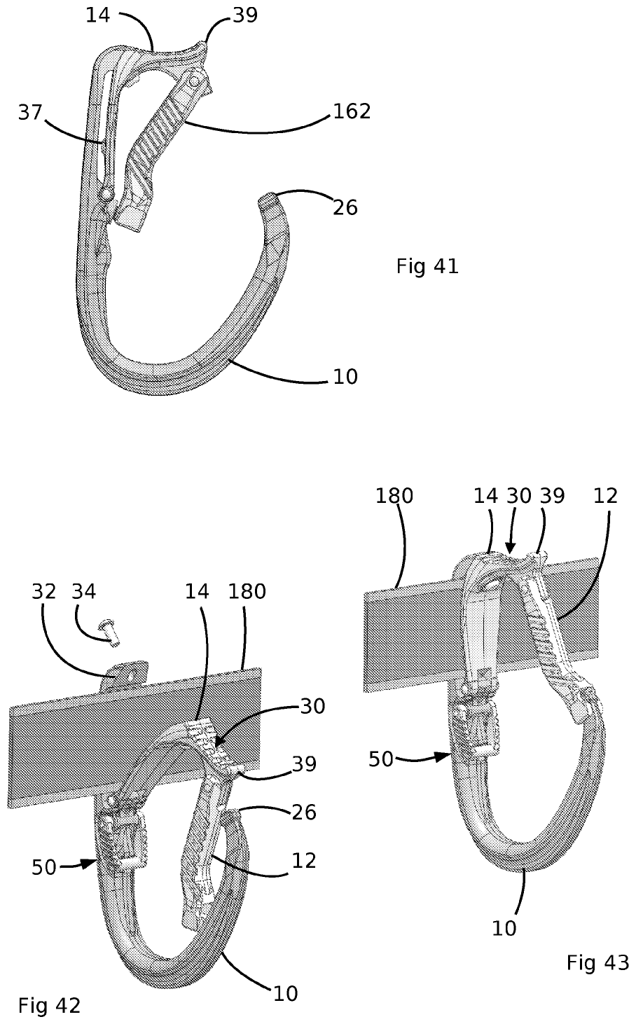

The embodiment of FIGS. 39 to 41, the gate retainer is constituted by co-operating magnetic elements.

A first magnetic element 164 is carried on the gate 162 close to its free end and facing generally towards the spine of the body component 10. A second magnetic element 166 is carried on the lower part 22 of the spine, positioned such that the first magnetic element 164 comes into contact with it when the gate 162 is moved to a fully-open position, whereby the magnetic elements 164, 166 constitute the gate retainer of this embodiment. The attractive force between the magnetic elements 164, 166 when in contact with one another is sufficient to prevent the gate 162 returning to its closed position under the action of the closing spring. However, when the magnetic elements 164, 166 are separated by more than a threshold distance, the attractive force becomes less than the closing spring force, with the result that they become inoperative as a gate retainer, so the gate will then close. In this embodiment, no part of the gate retainer projects into the space within the body beyond the space occupied by the gate 162. This minimises the chance that an object being passed though the opening into the carabiner body will release the gate retainer and allow the gate 162 to close.

The magnetic elements 164, 166 may include a permanent magnet and a piece of ferromagnetic material or they may both be permanent magnets, with their poles suitably arranged to ensure mutual attraction occurs between them.

The racking carabiner is intended for connection to an attachment point on an article such as a harness or a work belt being worn by a person climbing or working at height, for general tool carrying on a tool belt. In addition to hand tools, items carried may include cordless machine tools such as drills. Most harnesses for industrial, arborist, and climbing use will have multiple attachment points that a racking carabiner can be attached to, allowing for several racking carabiners to be attached to the harness at the same time if desired. The attachment points differ between harnesses, especially between those that are used in different fields of application (e.g. attachment point on a climbing harness compared to those on a harness for arborism), and embodiments of the invention should ideally fit well on all attachment points. When attached to a harness or tool belt it is important that the racking carabiner is held securely, because if there is significant movement it makes it more difficult to take tools on and off.

Application of the above embodiments to a harness will now be described with reference to FIGS. 42 and 43. This can be carried out prior to sale of a harness or other article by a manufacturer or as a retro-fit by, for example, a retailer, employer, or end user.

In this example, the attachment point comprises a length of webbing 180 is a component of a harness or work belt. It could alternatively be a harness substrate component (a semi-load-bearing component upon which a complete harness is assembled). When assembled, the upper section 20 of the spine may lie against or adjacent to a substrate of the harness. When the harness is in use, the webbing extends approximately horizontally when the user of the harness or belt is standing upright.

The closing component 14 is first pivoted to the open condition, as shown in FIG. 42. The upper section 20 of the spine is passed upwardly between the webbing 180 and an adjacent component, such as a harness substrate so that the boss 32 is exposed above the webbing 180, as shown in FIG. 42. The closing component 14 is then pivoted to the closed condition, as shown in FIG. 43, and is then secured by the bolt 34. The installed carabiner is shown in FIG. 43 with the webbing being within the slot formed between the shaft portion 28 and the recess in the upper section 20. In the closed condition, it is preferable that the webbing 180 is firmly clamped between the spine and the closing component 14 to prevent movement of the carabiner with respect to the harness. A projection 37 provides a localised region of high clamping pressure to enhance grip on the webbing 180. This is not, however, essential for the safe operation of the carabiner since the webbing 180 cannot be removed from the slot without first removing the bolt 34. If required, one or more elastomeric rings can be applied to the upper portion 20 of the spine to enhance its clamping of the webbing 180.

Once the carabiner has been installed, a carrying loop or strap of an item of equipment can be passed into the loop of the carabiner by displacing the gate 12 away from its closed condition and then hung upon the lower section 22 of the body 10, which acts as a hook from which the item can be hung. The item can be removed for use by displacing the gate 12 away from its closed condition and removing it from the loop. It will be noted that a racking carabiner is designed to transfer load from the spine of the carabiner body 10 to the webbing 180 or other component of a harness to which it is attached. This differs from a connecting carabiner which is intended to transfer load between components disposed at opposite ends of its body.

The carrying loop or strap of an item can be temporarily supported on the concave upper surface of the cross portion 30 of the closing component 14; the cross portion 30 acts as a shelf upon which items can be supported. A lip 39 on the upper surface of the cross portion 30 reduces the likelihood that the loop or strap will slide off.

In yet further embodiments, the closing component may be omitted altogether, with the main body component being extended to form an approximate C-shape, as in a conventional carabiner, that includes, for example, a hook formation for attachment to a harness component.

Embodiments of the invention may be shaped and dimensioned to accommodate specific items. For example, embodiments may be provided that are intended for work on general work sites for holding, amongst other things, cordless power tools such as drills or impact drivers, in which case, the carabiner might be dimensioned to hold tools made by major manufacturers. Embodiments may be intended for use on winter sport harnesses e.g., for the racking of ice screws. They may also find application by people setting routes on climbing walls for holding bags of holds, fixings and cordless power tools.

What is claimed is:

1. An arrangement for carrying components comprising a first component that has an attachment formation, which attachment formation includes a length of tensile material that is connected to an attachment point on an article being worn by a person climbing or working at height; and a racking carabiner connected to the attachment formation; the racking carabiner comprising:
a. an approximately C-shaped carabiner body that has a pivot end portion and a nose end portion, between which an opening is defined;
b. a gate pivotally connected to the body at the pivot end portion, and pivotable between a closed position, in which a connecting end portion of the gate engages with the nose end portion of the body to form a complete loop with the body and close its opening, and open positions in which the connecting end portion of the gate is spaced from the nose end portion of the body to at least partially open its opening;
c. a gate retainer that can adopt an inoperative condition, in which it presents no restriction to movement of the gate between the closed and open positions and an operative position in which it inhibits movement of the gate from a retained-open position towards the closed position.

2. The arrangement of claim 1 in which the gate retainer is carried on one or other of the carabiner body and the gate of the carabiner.

3. The arrangement of claim 1 in which the gate retainer includes a clip that can be transformed between the inoperative and operative conditions by pivoting it about a connection with a component of the carabiner to which it is connected between inoperative and operative positions.

4. The arrangement of claim 3 in which the gate retainer includes biasing components that urge the clip to pivot towards the inoperative position.

5. The arrangement of claim 4 in which the biasing components include one or more springs that act between the clip and the carabiner body.

6. The arrangement of claim 3 in which the clip is formed of resilient material that is deformed by pivoting between the inoperative and operative positions.

7. The arrangement of claim 6 in which the deformation causes a restoring force to be applied to the clip that urges it towards the inoperative position.

8. The arrangement of claim 3 in which the clip is U-shaped, having two side arms interconnected by a crossbar.

9. The arrangement of claim 8 in which the operative condition, the side arms are located on opposite sides of the gate.

10. The arrangement of claim 8 in which the operative condition, the crossbar is received into a groove on the gate.

11. The arrangement of claim 1 in which the gate retainer includes a toggle assembly that has an elongate flexible element to which a toggle is attached, the flexible element being secured to one of the carabiner body or the gate and the toggle being releasably connectable to the other of the carabiner body or the gate to retain the gate in a retained-open position.

12. The arrangement of claim 11 in which the flexible element is elastomeric.

13. The arrangement of claim 1 in which the gate retainer includes a first magnetic element secured to the gate and second magnetic element secured to the carabiner body, the first and second magnetic elements being operative to maintain the gate at a retained-open position by their mutual magnetic attraction.

14. The arrangement according to claim 13 in which at least one of the magnetic components is a permanent magnet.

15. The arrangement of claim 1 in which the gate retainer, in the operative condition, inhibits movement of the gate from a retained-open position towards the closed position; the gate being movable to a fully-open position wherein the retained-open position is between the fully-open position and the closed position.

16. The arrangement of claim 1, in which displacement of the gate retainer from the operative condition requires movement of the gate from the retained-open position towards the fully-open position.

17. The arrangement of claim 1 in which the carabiner body includes attachment components which can be used to connect the carabiner to a supporting structure, such as a belt or a webbing or other component of a harness.

18. The arrangement of claim 1 in which the carabiner body is a one-piece component.

19. The arrangement of claim 1 in which the carabiner body includes: a body component and a closing component, the closing component being pivotally interconnected to the body component and movable between an open condition and a closed condition in which, in the closed condition, the body component and a closing component are in contact with one another at a contact location remote from the pivotal interconnection, a slot being defined between portions of the body component and the closing component respectively and extending between the pivotal interconnection and the contact location; and in the open condition, the body component and a closing component are spaced from one another at the contact location, thereby opening the slot; there being a locking arrangement that can be operated to prevent movement of the closing component from the closed condition.

20-21. (canceled)

22. The arrangement of claim 1 in which the attachment formation is a component of a harness.

23. The arrangement of claim 22 in which the attachment formation is a component of a tool-carrying belt.
